(19) United States
(12) Patent Application Publication
(10) Pub. No.: US 2005/0086450 A1
(43) Pub. Date: Apr. 21, 2005

(54) Information processing apparatus and file management method

(76) Inventor: Noriyuki Shiota, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/929,601

(22) Filed: Aug. 31, 2004

(30) Foreign Application Priority Data
Sep. 1, 2003 (JP) NO. 2003-308715

(51) Int. Cl. G06F 12/08

(52) U.S. Cl. 711/207

(57) ABSTRACT

An information processing apparatus that uses a virtual memory function for executing a program is provided. The information processing apparatus includes: a file management part for managing a file in a read-only memory; a table generation part for generating a table in which a physical address of the program in the file in the read-only memory is associated with a virtual address of the program; a program execution part for obtaining the physical address of the program in the read-only memory by using the table from the virtual address of the program so as to execute the program on the read-only memory.

### BACKGROUND OF THE INVENTION

1. Field of the Invention

The present invention relates to an information processing apparatus and a file management method. More particularly, the present invention relates to an information processing apparatus using a virtual memory function and to a file management method used in the information processing apparatus.

2. Description of the Related Art

In an information processing apparatus such as a PC (personal computer) uses a file as a unit for storing a program or data. In addition, the information processing apparatus manages files by storing them in one or more locations called directories. The directory is treated like a file. Thus, files and directories form a recursive tree structure (hierarchical structure). A storing location for files of a tree structure shown in FIGS. 14A-14C is called a file system.

Normally, the file system is stored in an external storage unit such as a hard disk unit (to be referred to as HDD hereinafter). Since there is a limit on the capacity of an external storage unit, the information processing apparatus provides a capability to connect a directory of a file system to another file system. This connection process is called “mount”. The directory to which another file system is connected is called a mount point. By repeating the mount in the information processing apparatus, the file system shown in FIGS. 14A-14C can be expanded to one shown in FIG. 15 while the tree structure is maintained.

In the information processing apparatus that uses the file system, a file system is set beforehand as a start point of the tree structure of the file system. The file system set as the start point of the tree structure is called a root file system.

For mounting a plurality of file systems to construct a file system, it is necessary that the information processing apparatus specifies mount points on which each file system is mounted while a launching process is being performed. Since it is not realistic that a user specifies each mount point manually in the launching process, the information processing apparatus stores a definition file defining predetermined file systems and the mount points in the root file system.

The information processing apparatus reads the definition file from the root file system in the launching process, and mounts file systems on each mount point based on relationships between the file systems and the mount points defined in the definition file so that the file system such as one shown in FIG. 15 is constructed.

The HDD that is generally used as the external storage unit storing the file system has drawbacks of weakness to shock, large power consumption, large size, short life and the like. Thus, the HDD is not suitable for an embedded type information processing apparatus. Due to such characteristics of the HDD, the embedded type information processing apparatus usually stores the file system in a read-only-memory (to be referred to as ROM hereinafter).

If the file system is stored in the external storage unit such as the HDD, an central processing unit (to be referred to as CPU hereinafter) cannot read or write data in the external storage unit directly. Thus, after the data in the external storage unit is copied to a random-access memory (to be referred to as RAM hereinafter), the CPU accesses the data in the RAM. The data in the RAM accessed by the CPU is written back to the external storage unit. When a program in the external storage unit is executed, data accessed by the CPU needs to exist in the RAM.

In a case where the file system is stored in the ROM, there are many cases where the information processing apparatus copies the data in the ROM to the RAM before executing the data in consideration of compatibility of an operation interface used when the file system is stored in the external storage unit such as the HDD.

In addition, in the information processing apparatus such as the PC and the like, the operating system (to be referred to as OS hereinafter) that realizes multiprocess performs address management by using a virtual memory function to provide a virtual address space for each process. In the virtual memory function, a method of paging is used for protect a memory from being accessed by other processes. In the paging method, each of a virtual address space provided to a process and a physical memory space in a physical memory is divided into pages of a size determined by a processor, and correspondence between a page in the virtual address space and a page in the physical address space is managed so that a virtual address is converted into a physical address.

In the paging method, correspondence between a page of the virtual address space and a page of the physical address space is managed by using a conversion table called a page table. The page table is necessary for each process that has a virtual address space. By adopting the paging method, address conversion for converting a virtual address to a physical address is necessary for every memory access. Thus, it is indispensable to use hardware from the view point of execution speed. The address conversion is performed by a memory management unit (to be referred to as MMU) in the processor, and the conversion method is different to each processor.

For example, a MMU of a processor sets a physical address of the page table in a control register so as to automatically search the page table in a memory to perform conversion to a physical address for performing memory access. In this case, when a process is switched to another process, a physical address of another page table is set in the control register.

In addition, in a MMU in another processor, the page table is not automatically searched. The MMU performs conversion to a physical address by searching only a conversion table in the processor called a translation look aside buffer (to be referred to as TLB). In this case, if an entry of a virtual address to be accessed does not exist in the TLB, a TLB exception error occurs, and a handler of the TLB exception error searches the page table by software. Then, an entry based on the result of the search is added to the TLB.

Further, in a MMU that uses a method called demand paging, only a page that includes data necessary for executing the process is read from the file system and the page is written to the physical memory. After that, the page table is rewritten, so that the physical address is mapped to the virtual address of the process.

Japanese laid-open patent application No.2002-259190 (document 1) discloses a technology in a case where a file system is stored in a ROM. Japanese laid-open patent application No.7-160583 discloses a technology relating to the virtual memory function.

In an embedded type information processing apparatus, the file system is usually stored in the ROM not in the external storage unit such as the HDD. As shown in FIG. 16, since the CPC can check physical addressees in the ROM in a manner similar to RAM, the CPU may directly executes a program in the ROM. However, in a conventional information processing apparatus, even when the file system is stored in the ROM, there are many cases where the program is executed after the program in the ROM is copied to the RAM in consideration of compatibility with an operation interface used when the file system is stored in the external storage unit.

As mentioned above, since a program in the ROM is copied to the RAM for executing the program even when the file system is stored in the ROM, the RAM requires an additional capacity corresponding to the size of the program. As a result, there is a problem in that the capacity of RAM cannot be reduced even when the file system is stored in the ROM in the conventional information processing apparatus.

### SUMMARY OF THE INVENTION

An object of the present invention is to provide an information processing apparatus and a file management method for reducing the capacity of the RAM necessary for executing a program in the ROM by using the virtual memory function.

The above-object is achieved by an information processing apparatus that uses a virtual memory function for executing a program, the information processing apparatus including:
a file management part for managing a file in a read-only memory;
a table generation part for generating a table in which a physical address of the program in the file in the read-only memory is associated with a virtual address of the program;
a program execution part for obtaining the physical address of the program in the read-only memory by using the table from the virtual address of the program so as to execute the program on the read-only memory.

The above-object is also achieved by a file management method used in an information processing apparatus that uses a virtual memory function for executing a program, the file management method including:
a table generation step of generating a table in which a physical address of the program in a file in a read-only memory is associated with a virtual address of the program;
a program execution step of obtaining the physical address of the program in the read-only memory by using the table from the virtual address of the program so as to execute the program on the read-only memory.

According to the present invention, the capacity of the random-access memory necessary for executing a program in the read-only memory by using a virtual memory function can be reduced.

### BRIEF DESCRIPTION OF THE DRAWINGS

Other objects, features and advantages of the present invention will become more apparent from the following detailed description when read in conjunction with the accompanying drawings, in which:

FIG. 1 is a hardware block diagram of an example of an information processing apparatus of the present invention;

FIG. 2 is a figure for explaining a state when a program is launched in a case where a HDD is used as a storing location of a file system;

FIG. 3 is a first example for explaining a state of an executed program in a case where a ROM is used as a storing location of the file system;

FIG. 4 is a second example for explaining a state of an executed program in a case where a ROM is used as a storing location of the file system;

FIG. 5 is a third example for explaining a state of an executed program in a case where a ROM is used as a storing location of the file system;

FIG. 6 is a block diagram of an example of a kernel for realizing the first to third examples;

FIG. 7 shows a sequence diagram showing an example of the operation of the kernel when a file on the HDD file system is executed;

FIG. 8 shows a sequence diagram showing an example of the operation of the kernel when a file on the ROM file system is executed;

FIG. 9 shows a sequence diagram showing another example of the operation of the kernel when a file on the ROM file system is executed;

FIG. 10 is figure for explaining a vnode;

FIG. 11 is figure for explaining a mount table;

FIG. 12 is a block diagram of an example of a compound machine of the present invention;

FIG. 13 shows an example of a hardware configuration of the compound machine;

FIGS. 14A-14C are figures for explaining file systems;

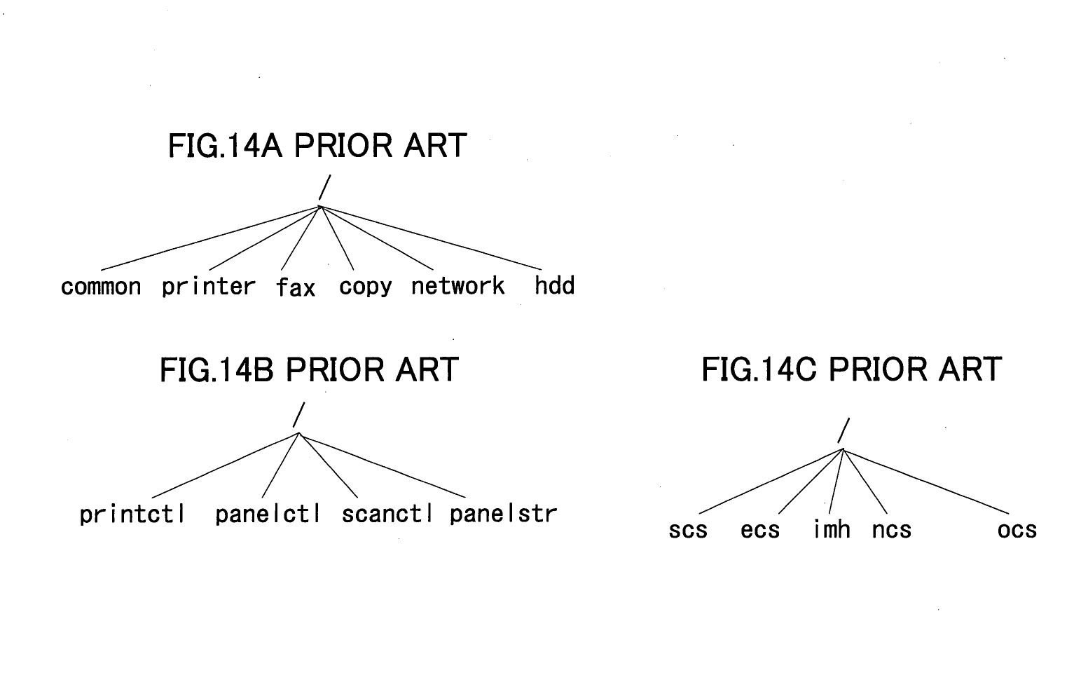

FIG. 15 is a figure for explaining mount of the file system;

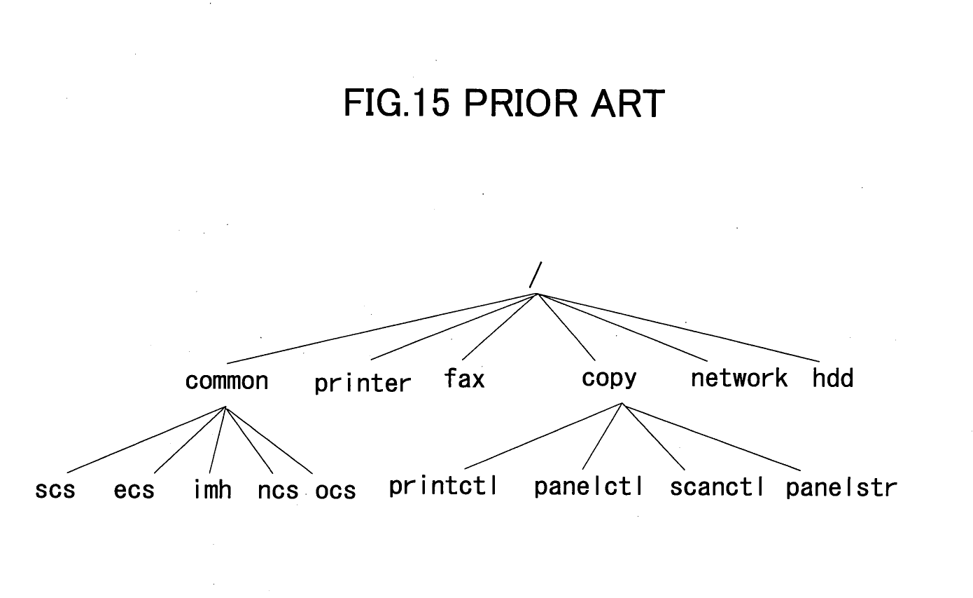

FIG. 16 shows an example of a physical address space in a memory from a viewpoint of CPU.

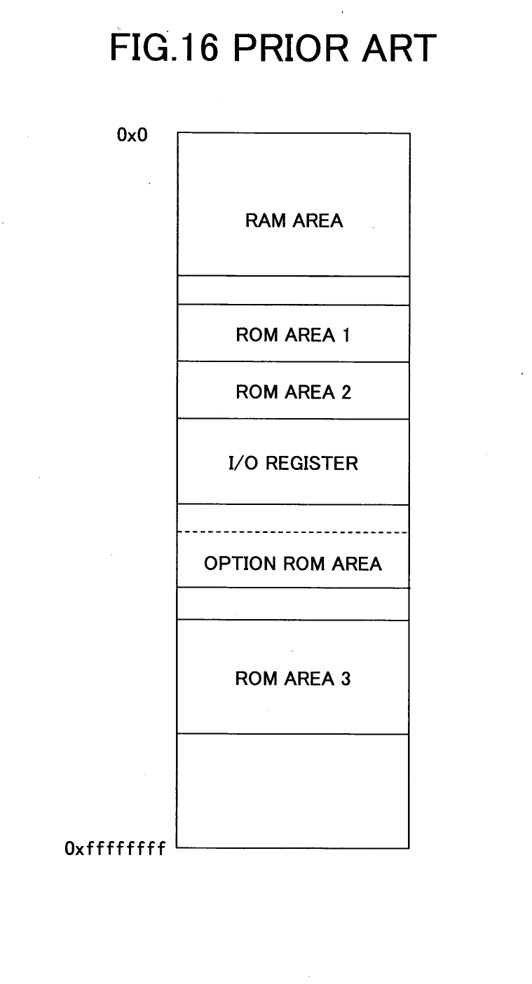

### DETAILED DESCRIPTION OF THE PREFERRED EMBODIMENTS

In the following, embodiments of the present invention are described with reference to figures.

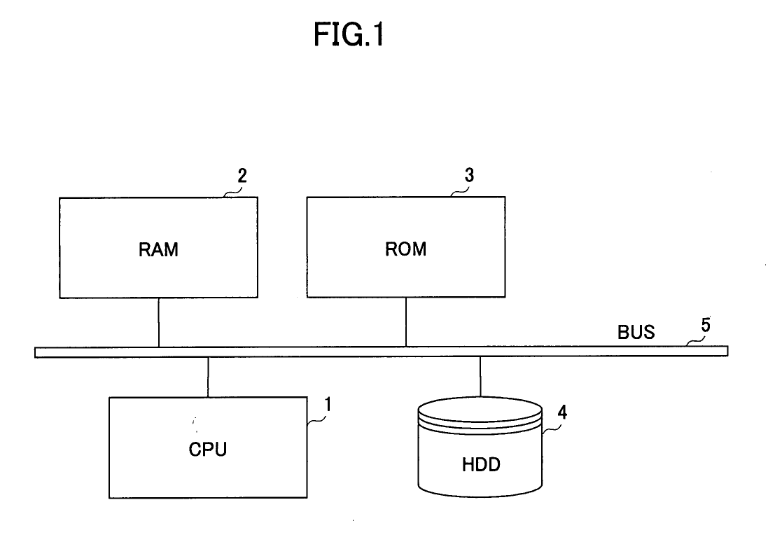

FIG. 1 is a hardware block diagram of an example of the information processing apparatus of the present invention. The information processing apparatus shown in FIG. 1 includes a CPU 1, a RAM 2, a ROM 3, a HDD 4 and a bus 5 in which the CPU 1, the RAM 2, the ROM 3 and the HDD 4 are connected to the bus 5. FIG. 1 shows a minimum configuration of the information processing apparatus. The information processing apparatus may further include an input device such as a key board, a mouse and a display device. The bus 5 may be a simple bus or a bus including a bus bridge.

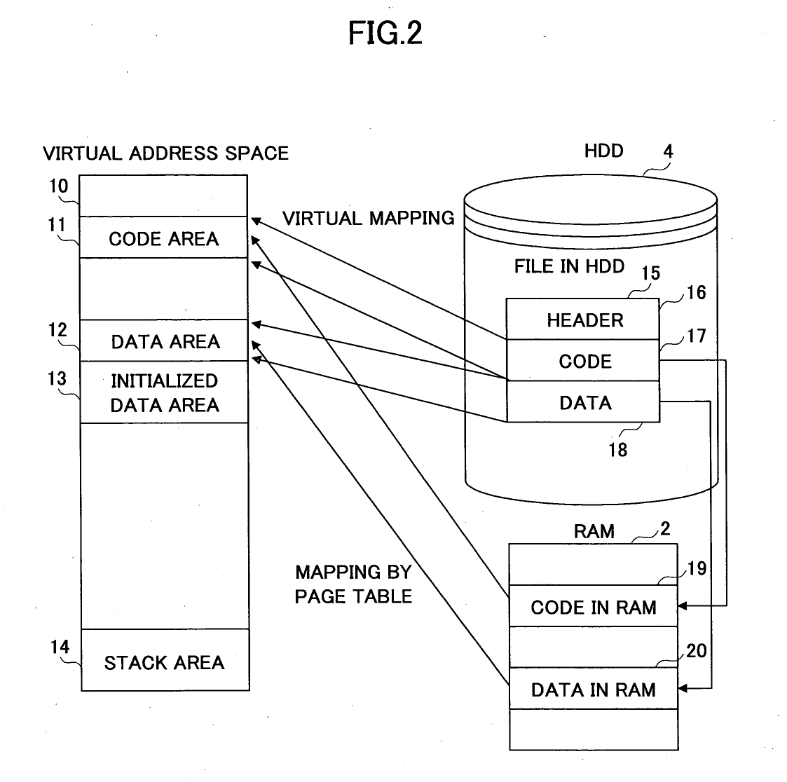

FIG. 2 is a figure for explaining a state when a program is launched in a case where the HDD is used as a storing location of the file system. The HDD 4 stores the file system (to be referred to as a HDD file system hereinafter). When a file 15 in the HDD file system is launched as a program, an environment (to be referred to as a process hereinafter) for executing the program is generated. A different virtual address space 10 is assigned to each process.

A code area 11, a data area 12, an initialized data area 13 and a stack area 14 of the program are virtually mapped to specified addresses in the virtual address space 10. The virtual mapping does not mean to actually assign a physical memory, but it means that an environment is set such that a physical memory for storing actual data is assigned when the CPU accesses the virtual address in the virtual address space.

The code area 11 is an area in which an executable code of the program is stored. The data area 12 is an area in which data of an initial value is stored. The initialized data area 13 is an area in which data initialized to 0 is stored. The stack area 14 is an area used as a stack when the program is executed.

In a state where the code area 11 is virtually mapped to the virtual address space 10, when the CPU 1 accesses the code area 11, a page exception occurs so that a page exception handler is launched. The page exception handler reads code of a program corresponding to the accessed virtual address from the code area 17 in the HDD file system in units of page, and writes the code of the program in a code area 19 of the RAM 2 that is kept separately.

Further, the page exception handler sets correspondence between a physical address in the RAM 2 and a virtual address of the virtual address space 10 in a page table. Then, the page exception process ends. After the page exception process is performed, the CPU 1 resumes execution of the program so that the CPU 1 accesses the code area 11, reads the code of the program from the physical address of the accessed virtual address and executes the code.

The RAM 2 is virtually mapped to the initialized data area 13 and the stack area 14. When the CPU 1 accesses the initialized data area 13 or the stack area 14, the RAM 2 is assigned in units of page by the page exception handler.

Instead of using the HDD 4 as a storing location of the file system as shown in FIG. 2, if the ROM 3 is used as the storing location of the file system, the code of the program can be read on the basis of a physical address of the ROM 3 without writing the code into the RAM 2. Therefore, as mentioned later, by modifying the process of the page exception handler, the program in the ROM 3 can be executed while keeping the compatibility with the operation interface used when a program on the HDD file system is executed.

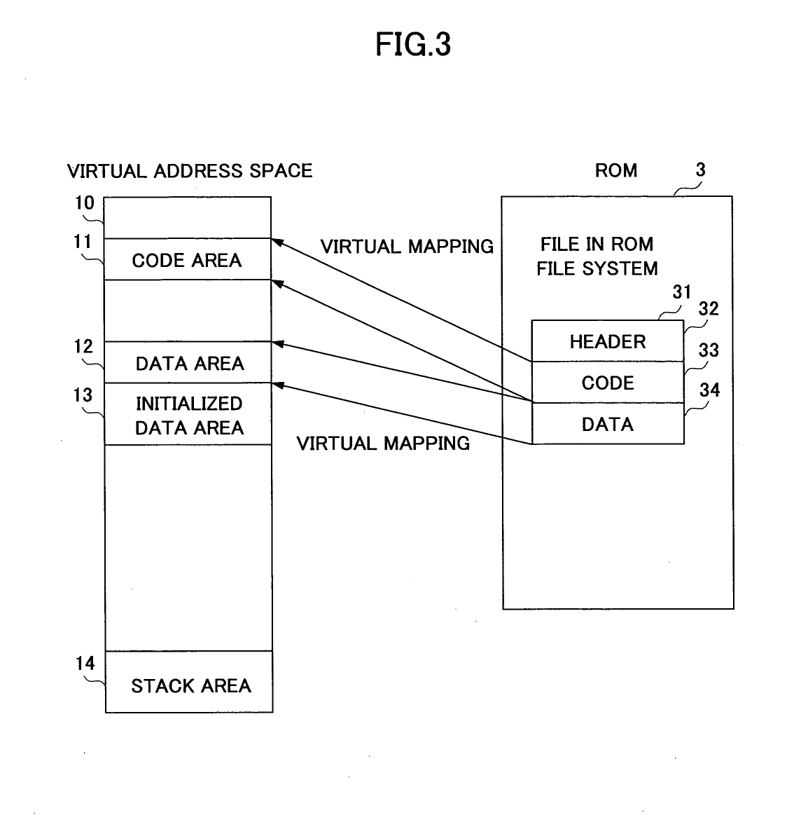

FIG. 3 is a first example for explaining a state when a program is launched in a case where the ROM is used as a storing location of the file system. The ROM 3 stores the file system (to be referred to as a ROM file system hereinafter). When a file 31 in the ROM file system is launched as a program, a process for the program is generated. A different virtual address space 10 is assigned to each process.

Like the case shown in FIG. 2, a code area 11, a data area 12, an initialized data area 13 and a stack area 14 are virtually mapped to specified addresses in the virtual address space 10. The code area 33 in the ROM file system is virtually mapped to the code area 11. The data area 34 in the ROM file system is virtually mapped to the data area 12.

In a state where the code area 11 is virtually mapped to the virtual address space 10, when the CPU 1 accesses the code area 11, a page exception occurs so that a page exception handler is launched. The page exception handler obtains a physical address in the code area 33 in the ROM file system corresponding to a virtual address accessed by the CPU 1.

Further, the page exception handler sets correspondence between the physical address in the ROM 3 and the virtual address of the virtual address space 10 in a page table. Then, the page exception process ends. After the page exception process is performed, the CPU 1 resumes execution of the program so that the CPU 1 accesses the code area 11, reads the code of the program from the physical address in the ROM 3 corresponding to the accessed virtual address and executes the code.

In the same way as the case where the CPU 1 accesses the code area 11, when the CPU 1 accesses the data area 12, the page exception handler changes information in the page table, and the CPU 1 directly accesses a physical address in the ROM 3 corresponding to the accessed virtual address.

In the example shown in FIG. 3, although there is a limitation that data in the data area 12 cannot be rewritten, the memory capacity of the RAM 2 can be largely reduced compared to a case where the code area 33 and the data area 34 in the ROM 3 are copied to the RAM 2 for executing the program.

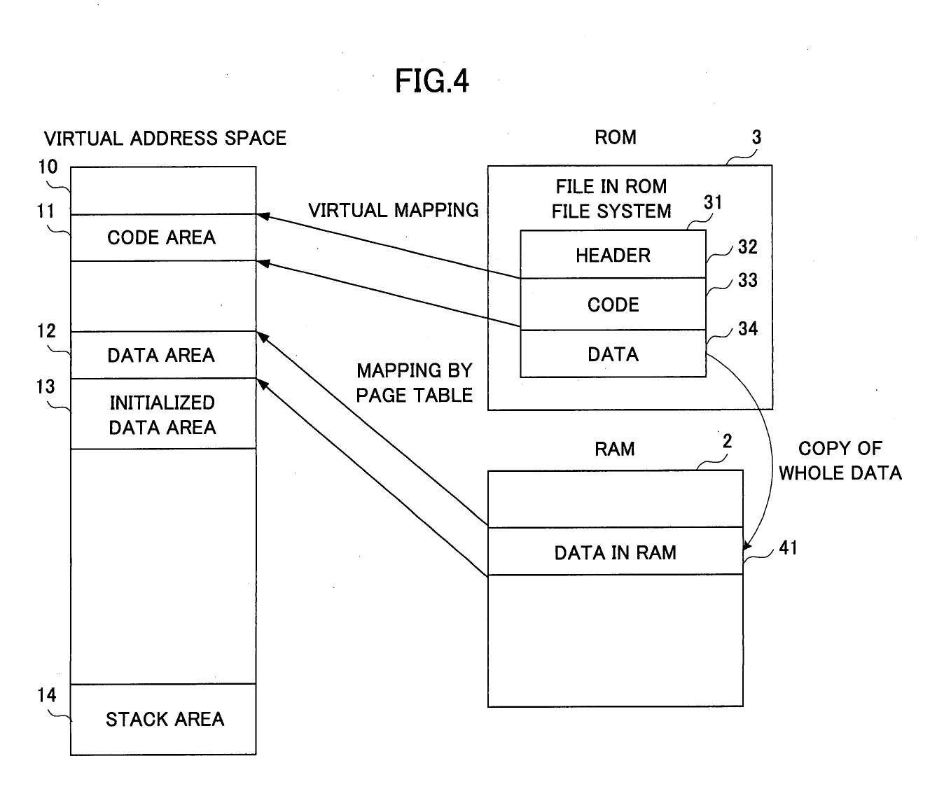

FIG. 4 is a second example for explaining a state when a program is launched in a case where the ROM is used as a storing location of the file system. The ROM 3 stores the ROM file system. When a file 31 in the ROM file system is launched as a program, a process for the program is generated. A different virtual address space 10 is assigned to each process.

Like the case shown in FIG. 2, a code area 11 of the program, a data area 12, an initialized data area 13 and a stack area 14 are virtually mapped to specified addresses in the virtual address space 10. In addition, a data area 41 in the RAM copied from the data area 34 in the ROM file system is directly mapped to the data area 12 wherein this mapping is initially set in the page table.

A process similar to the case shown in FIG. 3 is performed when the CPU 1 accesses the code area 11 in this state. On the other hand, a process performed when the CPU 1 accesses the data area 12 is different from one shown in FIG. 3. The CPU 1 obtains, from the page table, a physical address of the RAM 2 corresponding to the accessed virtual address of the data area 12, and directly accesses the data area 41 in the RAM 2.

In the example shown in FIG. 4, although there is a limitation that a memory capacity same as the size of the data area 34 is required for the RAM 2 for accessing the data area 34, there are merits that the data of the data area 34 can be rewritten and the memory capacity of the RAM 2 can be reduced compared to a case where the code area 33 and the data area 34 in the ROM 3 are copied to the RAM 2 for executing the program.

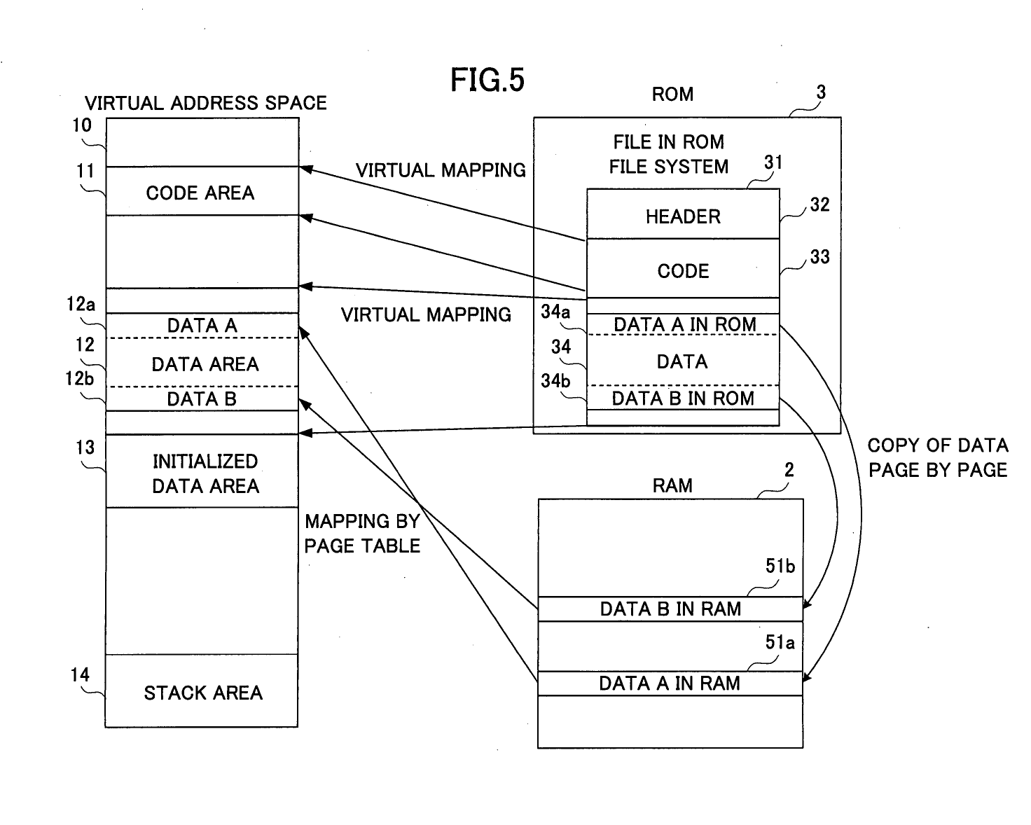

FIG. 5 is a third example for explaining a state when a program is launched in a case where the ROM is used as a storing location of the file system. The ROM 3 stores the ROM file system. When a file 31 in the ROM file system is launched as a program, a process of the program is generated. A different virtual address space 10 is assigned to each process.

Like the case shown in FIG. 2, a code area 11 of the program, a data area 12, an initialized data area 13 and a stack area 14 are virtually mapped to specified addresses in the virtual address space 10. The code area 33 in the ROM file system is virtually mapped to the code area 11, and the data area 34 in the ROM file system is virtually mapped to the data area 12.

A process similar to the case shown in FIG. 3 is performed when the CPU 1 accesses the code area 11 in this state. When the CPU 1 accesses the data area 12, a page exception occurs so that a page exception handler is launched in the same way as the case shown in FIG. 3. The process of the page exception handler is difference between this example and the example of FIG. 3 is different.

First, a case where the CPU 1 performs a process for reading data from the data area 12 is described. When the CPU 1 performs a process for reading data from the data area 12, the page exception handler obtains a physical address, in the data area 34 in the ROM file system, corresponding to the accessed virtual address.

Further, the page exception handler sets correspondence between the physical address of the ROM 3 and the virtual address of the virtual address space 10. Then, the page exception process ends. After the page exception process is performed, the CPU 1 resumes execution, accesses the data area 12 so as to directly access the physical address of the ROM 3 corresponding to the accessed virtual address and reads the data.

Next, a case where the CPU 1 performs a process for writing data to the data area 12 is described. When the CPU 1 performs a process for writing data to the data area 12, the page exception handler keeps an area of one page in the RAM 2. Next, the page exception handler reads data corresponding to the accessed virtual address in units of page from the data area 34 of the ROM file system, and writes the data into the kept area of the RAM 2.

For example, if the virtual address accessed by the CPU 1 is data A 12a in the data area 12, the page exception handler reads data A 34a corresponding to the data A 12a in the data area 12 in units of page from the data area 34 in the ROM file system, and writes the data into the kept area 51a in the RAM 2.

Further, the page exception handler sets correspondence between the physical address of the area 51a in which the data A is written and the virtual address of the virtual address space 10 in the page table. Then, the page exception process ends.

In this state, when the CPU 1 accesses the data A 12a in the data area 12, the CPU 1 obtains the physical address of the RAM 2 corresponding to the virtual address of the data A 12a from the page table so as to access the data A in the RAM 2 to which the data A 34a in the ROM file system has been copied. If the virtual address accessed by the CPU 1 corresponds to the data B 12b in the data area 12, the similar process as the above-mentioned case is performed. After that, when the CPU 1 reads data from the data A 12a, the CPU 1 reads the data A in the area 51a that is mapped by the page table not the data A 34a in the ROM 3.

The process described with reference to FIG. 5 is known as “copy on write”. Conventionally, the “copy on write” was applied for rewriting data shared by a plurality of processes. In the example of FIG. 5, the “copy on write” is applied to a file in the ROM file system that is not rewritable.

In the example of FIG. 5, since a part instructed to be rewritten is copied to the RAM 2 in units of page when a program is executed, the data in the data area 34 can be rewritten on the RAM 2. Thus, the memory capacity of the RAM 2 can be reduced compared to a case where the code area 33 and the data area 34 of the ROM 3 is copied to the RAM 2.

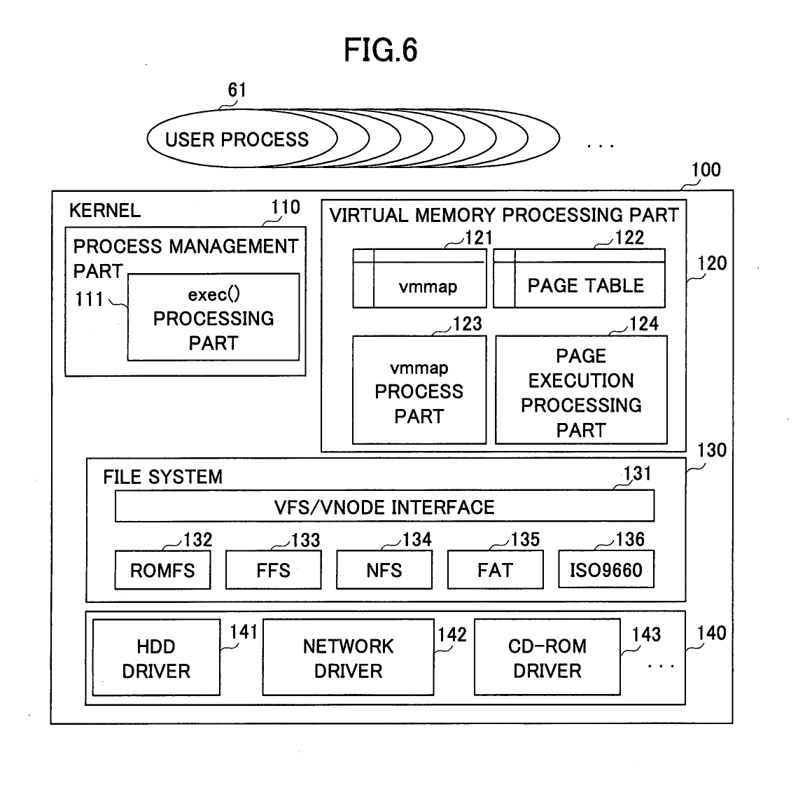

In the following, a configuration and processes of a kernel for realizing the first to third examples shown in FIGS. 3.-5 are described. FIG. 6 is a block diagram of an example of a kernel for realizing the first to third examples. A user process 61 and a kernel 100 shown in FIG. 6 are launched by the information processing apparatus of the present invention.

The user process 61 is a process generated by a file in the HDD file system or the ROM file system as a program. The kernel 100 is the core of the OS such as UNIX.

The kernel 100 of FIG. 6 includes a process management part 110, a virtual memory processing part 120, a file system 130 and drivers 140. The process management part includes an exec ( ) processing part 111. The virtual memory processing part 120 includes a vmmap 121, a page table 122, a vmmap processing part 123 and a page exception processing part 124. The file system 130 includes a VFS/VNODE interface 131, a ROMFS 132, a FS 133, a NFS 134, a FAT 135 and an ISO 9660 136. In addition, the drivers 140 include a HDD driver 141, a network driver 142 and a CD-ROM driver 143.

The vmmap 121 in the virtual memory processing part 120 stores usage information of a virtual address space. The page table 122 manages correspondences between virtual addresses and physical addresses. The page table 122 may be accessed directly from the CPU 1. Since the configuration of the virtual address space and the correspondence between the virtual address and the physical address are different for each process, each of the vmmap 121 and the page table 122 are managed for each process.

The ROMFS 132 of the file system 130 is a read-only ROM file system using the ROM 3. The FFS 133 is a readable and writable first file system using the HDD 4. In this embodiment, the first file system is called a HDD file system. The NFS 134 is a network file system that enables to access a file of other apparatus connected to a network. Each of the FAT 135 and the ISO 9960 136 is an example of a file system.

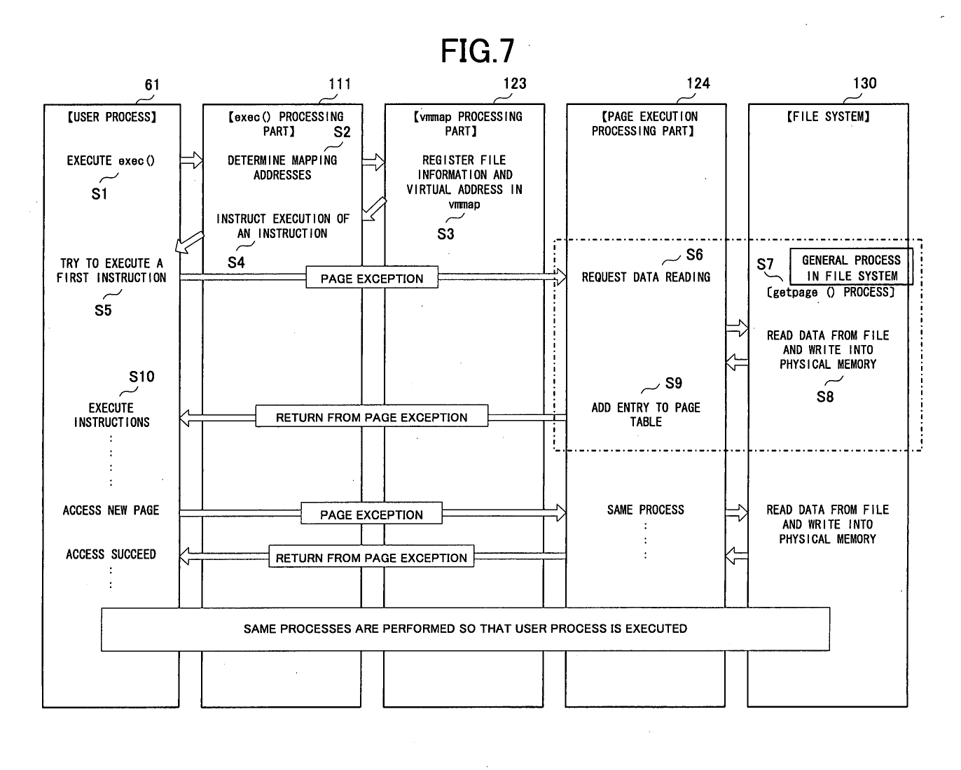

Next, to make the present invention easier to understand, processes of the kernel when the file on the HDD file system is executed are described with reference to FIG. 7. FIG. 7 shows a sequence diagram showing an example of the operation of the kernel when a file in the HDD file system is executed.

In step S1, a user process 61 executes exec ( ) by specifying a file 15 in the HDD file system for example. When the kernel receives the exec ( ) from the user process 61, the step goes to step S2. In step S2, the exec ( ) processing part 111 in the process management part 110 reads a header 16 of the file 15 designated for the exec ( ) and determines virtual addresses to which code and data are mapped. The exec ( ) processing part 111 sends the determined information to the vmmap processing part 123.

In step S3, the vmmap processing part 123 registers file information including a file name and a offset, and virtual addresses for mapping in the vmmap 121 of the user process 61. In step S4, the exec ( ) processing part 111 instructs the user process 61 to execute the code from the start address.

In step S5, the user process 61 tries to execute a first instruction on the basis of the start address of the code. However, since corresponding entry is not yet set in the page table 122, a page exception occurs. When the page exception occurs, the page exception processing part 124 that corresponds to the page exception handler keeps a code area 19 in the RAM 2 in step S6.

The page exception processing part 124 designates the file name and the offset based on the file information registered in the vmmap 121, and requests the file system 130 to read data. In step S7, on the basis of the request from the page exception processing part 124, the file system 130 performs getpage ( ) process that is common to each file system. The file system 130 reads data from the designated file and writes the data in the code area 19 kept in the RAM 2 (physical memory).

In step S9, the page exception processing part 124 adds, in the page table 122, an entry indicating correspondence between the physical address of the RAM 2 and the virtual address of the virtual address space 10 for mapping the physical address of the data in the RAM 2 to the virtual address of the user process 61. Then, the page exception process ends.

After returning from the page exception, the user process 61 executes the first instruction on the basis of the start address of the code in step S10. At this time, since the corresponding entry is set in the page table 122, the page exception does not occur. By repeating the above-mentioned process, the user process 61 is executed.

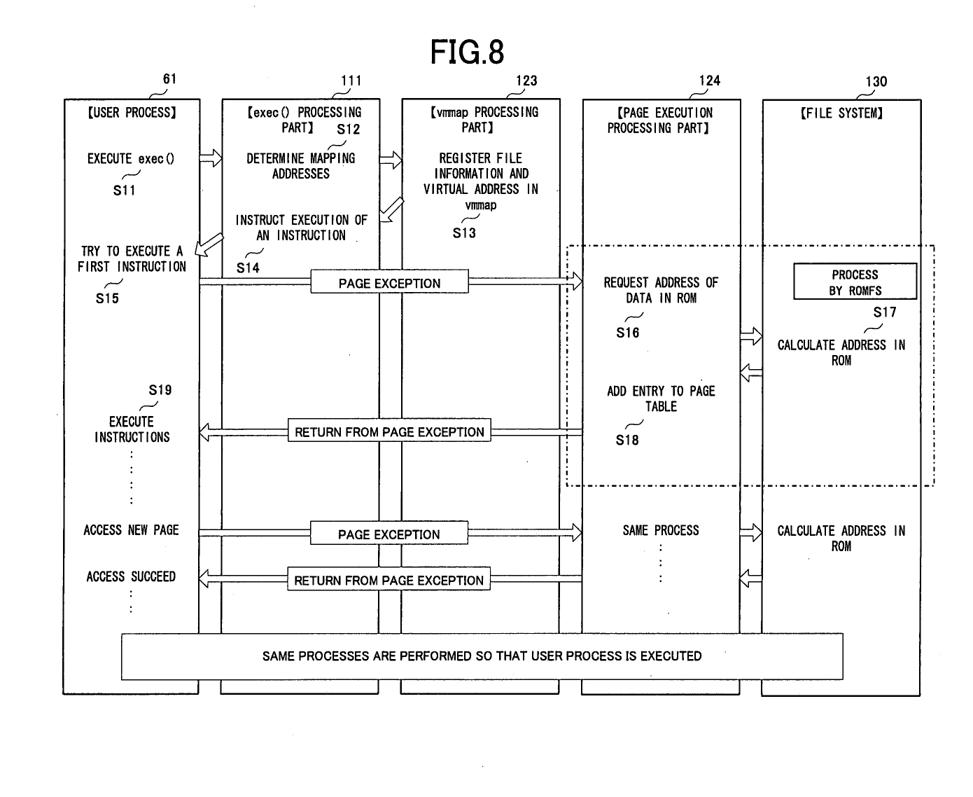

Next, the operation of the kernel when a file of the ROM file system is executed is described with reference to FIG. 8. FIG. 8 is a sequence diagram of a process performed by the kernel when the file in the ROM file system is executed.

In step S11, the user process 61 executes exec ( ) by specifying a file 31 in the ROM file system for example. When the kernel receives the exec ( ) from the user process 61, the step goes to step S12. In step S12, the exec ( ) processing part 111 in the process management part 110 reads a header 32 of the file 31 designated for the exec ( ) and determines virtual addresses to which code and data are mapped. The exec ( ) processing part 111 sends the determined information to the vmmap processing part 123.

In step S13, the vmmap processing part 123 registers file information including a file name and a offset, and virtual addresses for mapping in the vmmap 121 of the user process 61. In step S14, the exec ( ) processing part 111 instructs the user process 61 to execute the code from the start address.

In step S15, the user process 61 tries to execute a first instruction on the basis of the start address of the code. However, since a corresponding entry is not yet set in the page table 122, a page exception occurs. When the page exception occurs, the page exception processing part 124 determines whether the file exists in the ROM file system or in other file system as a way mentioned later and performs following processes according to whether the file exists in the ROM file system or in other file system in step S16. In the following, a case where the file exists in the ROM file system is described.

When it is determined that the file exists in the ROM file system, the page exception processing part 124 designates the file name and the offset on the basis of the file information registered in the vmmap 121, and requests the physical address of the file in the ROM 3 from the file system 130.

In step S17, on the basis of the request of the page exception processing part 124, the file system 130 calculates the physical address of the designated file on the ROM 3. Then, in step S18, the page exception processing part 124 adds, in the page table 122 of the user process 61, an entry indicating correspondence between the physical address of the ROM 3 and the virtual address of the virtual address space 10 for mapping the calculated physical address of the ROM 3 to the virtual address of the user process 61. Then, the page exception process ends.

After returning from the page exception, the user process 61 executes the first instruction on the basis of the start address of the code in step S19. At this time, since the corresponding entry is set in the page table 122, the page exception does not occur. By repeating the above-mentioned process, the user process 61 is executed.

In the sequence diagram of FIG. 8, since the page exception processing part 124 does not need to keep a new area in the RAM 2, the memory capacity of RAM 2 can be largely reduced compared with the case shown in FIG. 7.

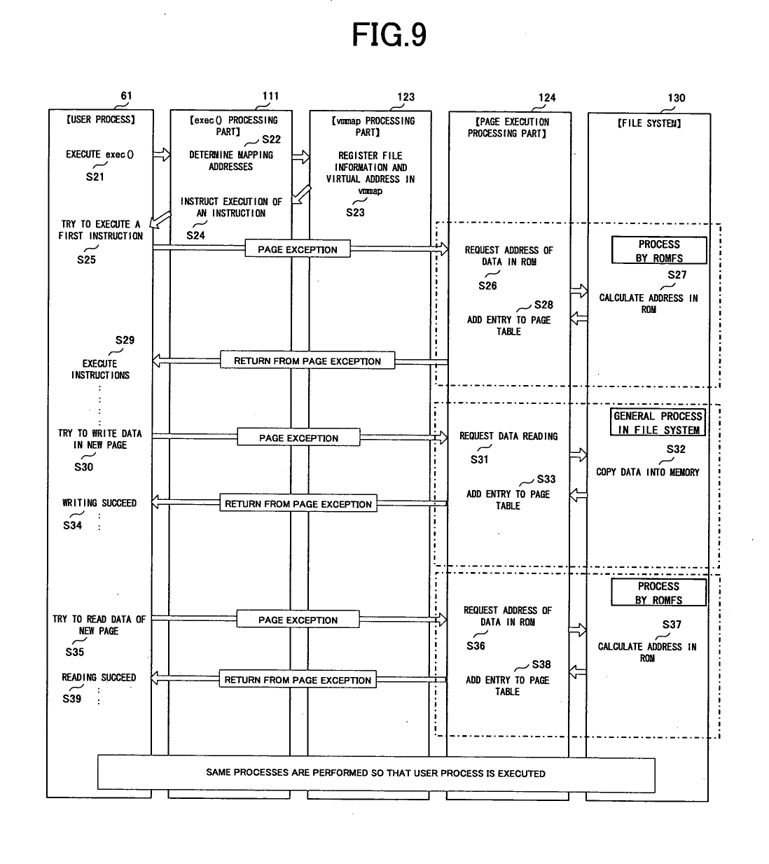

In the following, the operation of the kernel when a file in the ROM file system is executed is described with reference to FIG. 9. FIG. 9 is a sequence diagram of another example of the operation performed by the kernel when the file in the ROM file system is executed.

In step S21, the user process 61 executes exec ( ) by specifying a file 31 in the ROM file system for example. When the kernel receives the exec ( ) from the user process 61, the step goes to step S22. In step S22, the exec ( ) processing part 111 in the process management part 110 reads a header 32 of the file 31 designated for the exec ( ) and determines virtual addresses to which code and data are mapped. The exec ( ) processing part 111 sends the determined information to the vmmap processing part 123.

In step S23, the vmmap processing part 123 registers file information including a file name and an offset, and virtual addresses for mapping in the vmmap 121 of the user process 61. In step S24, the exec ( ) processing part 111 instructs the user process 61 to execute the code from the start address.

In step S25, the user process 61 tries to execute a first instruction on the basis of the start address of the code. However, since a corresponding entry is not yet set in the page table 122, a page exception occurs. When the page exception occurs, the page exception processing part 124 determines whether the file exists in the ROM file system or in other file system as a way mentioned later and performs following processes according to whether the file exists in the ROM file system or in other file system in step S26. In the following, a case where the file exists in the ROM file system is described.

When it is determined that the file exists in the ROM file system, the page exception processing part 124 designates the file name and the offset on the basis of the file information registered in the vmmap 121, and requests the physical address of the file in the ROM 3 from the file system 130.

In step S27, on the basis of the request of the page exception processing part 124, the file system 130 calculates the physical address of the designated file in the ROM 3. Then, in step S28, the page exception processing part 124 adds, in the page table 122 of the user process 61, an entry indicating correspondence between the physical address of the ROM 3 and the virtual address of the virtual address space 10 for mapping the calculated physical address of the ROM 3 to the virtual address of the user process 61. Then, the page exception process ends.

After returning from the page exception, the user process 61 executes the first instruction on the basis of the start address of the code in step S29. At this time, since the corresponding entry is set in the page table 122, the page exception does not occur.

In step S30, the user process 61 tries to write data into a new page. However, since an entry is not yet set in the page table 122, a page exception occurs. When the page exception-occurs, the page exception processing part 124 keeps, for example, a data area 51a in the RAM 2 in step S31.

The page exception processing part 124 designates the file name and the offset based on the file information registered in the vmmap 121, and requests the file system 130 to read data. In step S32, on the basis of the request from the page exception processing part 124, the file system 130 calculates the physical address of the designated file in the ROM 3. Then, the file system 130 reads data from the calculated physical address in the ROM 3, and writes the data into the data area 51a kept in the RAM 2.

In step S33, the page exception processing part 124 adds, in the page table 122 of the user process 61, an entry indicating correspondence between the physical address of the RAM 2 and the virtual address of the virtual address space 10 for mapping the physical address of the data in the RAM 2 to the virtual address of the user process 61. Then, the page exception process ends.

After returning from the page exception, the user process 61 writes data in step S34. At this time, since the entry in the page table 122 is set, the page exception does not occur.

In step S35, the user process 61 tries to read data from a new page. However, since a corresponding entry is not yet set in the page table 122, a page exception occurs. When the page exception occurs, the page exception processing part 124 determines whether the file exists in the ROM file system or in other file system as a way mentioned later and performs following processes according to whether the file exists in the ROM file system or in other file system in step S36. In the following, a case where the file exists in the ROM file system is described.

When it is determined that the file exists in the ROM file system, the page exception processing part 124 designates the file name and the offset on the basis of the file information registered in the vmmap 121, and requests the physical address of the file in the ROM 3 from the file system 130.

In step S37, on the basis of the request of the page exception processing part 124, the file system 130 calculates the physical address of the designated file on the ROM 3. Then, in step S38, the page exception processing part 124 adds, in the page table 122 of the user process 61, an entry indicating correspondence between the physical address of the ROM 3 and the virtual address of the virtual address space 10 for mapping the calculated physical address of the ROM 3 to the virtual address of the user process 61. Then, the page exception process ends.

After returning from the page exception, the user process 61 executes reading of the data in step S39. At this time, since the corresponding entry is set in the page table 122, the page exception does not occur.

In the sequence shown in FIG. 9, the area for which a write request is made is copied from the ROM 3 to the RAM 2. Thus, the data in the area can be rewritten, and the memory capacity of the RAM 2 can be reduced compared to the process in the sequence of FIG. 7. The example of FIG. 4 indicates an example in which the steps S31-S33 in the sequence of FIG. 9 are performed on the data area 34 in the ROM 3 at the time when the program is launched.

Next, the process performed by the page exception processing part 124 for determining whether the file exists in the ROM file system or in other file system is described. In the inside of the kernel 100, files and directories that are treated in the same way as files (to be collectively referred to as files hereinafter) are managed by vnodes. A vnode is generated for one file. The vnode is discarded when a corresponding file is not used for a predetermined time.

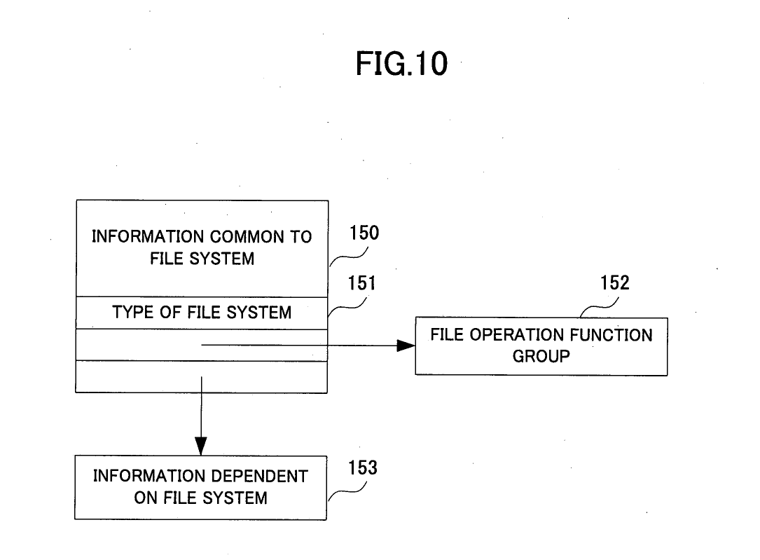

In the vnode, various pieces of information necessary for the kernel 100 to use the file are stored. FIG. 10 shows an example of a structure of the vnode. The vnode shown in FIG. 10 includes information 150 common to each file system necessary for operating the file, a file system type 151 that indicates which file system the file belongs to, a file operation function group 152 for operating the file, and information 153 depending on the file system to which the file belongs. Information on the vnode is held by the file system 130, for example.

Therefore, the process for determining whether the file exists in the ROM file system or in other file system is performed by searching a vnode of the file to obtain the file system type 151 of the vnode.

Next, details of processes for generating a vnode of a file designated by the exec ( ) processing part 111 are described. In a first process, a vnode is obtained for tracing file names, and the obtained vnode is set as a current vnode. For example, when the full path is specified for the file, a vnode of a root directory of the system is obtained. When a relative path is specified, a vnode of a current directory is obtained.

In a second process, if there is not a next component (name between “/” and “/”) in the file name, the current vnode is determined to be the vnode corresponding to the file. If there is a next component, the process goes to a third process. In the third process, the next component is read from a directory of the current vnode, and a vnode corresponding to the file is generated or searched for, and the vnode that is generated or searched for is determined to be a current vnode.

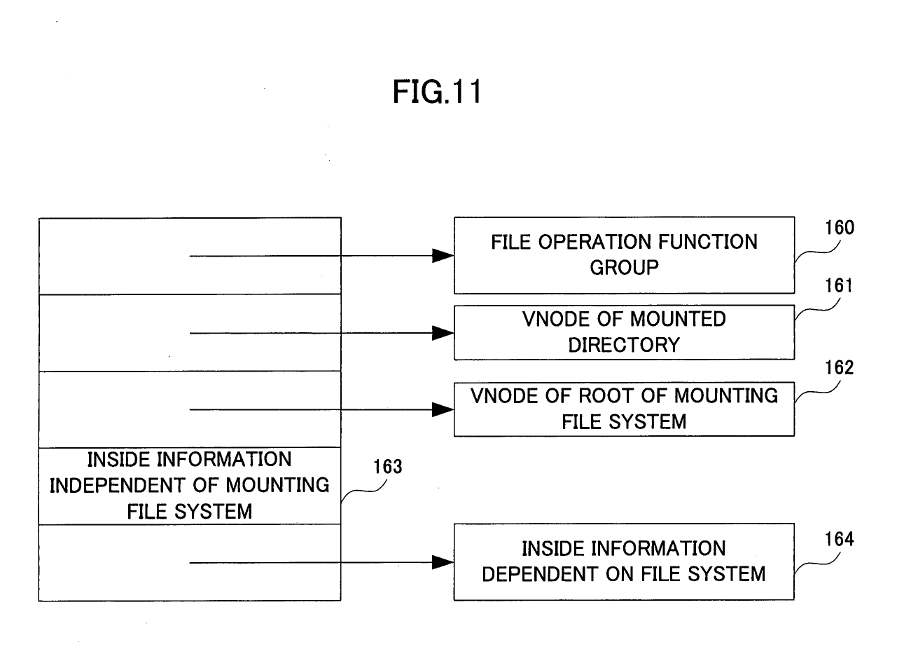

In a fourth process, it is checked whether other file system is mounted on the current vnode. When other file system is mounted on the current vnode, a root vnode of the mounted file system is obtained from a mount table shown in FIG. 11. Then, the obtained vnode is determined to be a current vnode. After the fourth process, the process returns to the second process and continues.

In the inside of the kernel, the mount table manages information indicating that each file system is mounted on which directory. At the time of mount processing, a vnode of the mounted directory and a root vnode of the mounting file system are registered in a mount table like one shown in FIG. 11.

FIG. 11 is a figure for explaining the mount table. The mount table shown in FIG. 11 includes a file system operation function group 160 for operating the file system, a vnode 161 of a mounted directory, a root vnode 162 of a mounting file system, inside information 163 independent from the file system and the mounting file system and, and inside information 164 depending on file systems.

The vnode obtained by the first to fifth processes is stored in a process structure that stores information of each process. The exec ( ) processing part 111 reads a header of a file by using a file reading function in the file operation function group 152 stored in the vnode. The header of the executable file includes offsets and lengths in the file for a code area and a data area. In addition, the header of the executable file includes information indicating locations in the virtual address space to which the code area and the data area are to be mapped.

The vmmap 121 includes a vnode, a start offset, a size, a virtual address, a size of the virtual address, and protecting information of a virtual address map for each of the code area, data area and the stack area.

In the following, the before-mentioned page exception process when data is read is described in detail. When the page exception occurs, the page exception processing part 124 obtains a virtual address at which the page exception occurs from a control register of the CPU 1. Next, the page exception processing part 124 searches the vmmap 121 of a currently executed process for values corresponding to the virtual address.

If a vnode obtained from the vmmap 121 is effective, the page exception processing part 124 obtains a type of the file system from the vnode. If the type of the file system is “romfs”, the page exception processing part 124 calls a file system operation function “get_addr( )” by specifying an offset from the head of the area and a vnode. The get_addr( ) of the romfs file system calculates a physical address in the ROM corresponding to the offset in the specified vnode, and returns the physical address to the page exception processing part 124. The page exception processing part 124 sets the returned physical address with a write-protect attribute in a page table entry at which the exception occurred. After that, the page exception processing part 124 returns from the page exception.

If the type of the file system is other than the romfs, a physical memory area of one page is kept in the RAM 2. Then, the get_page ( ) is called by specifying an offset from the head of the area and a vnode. The get_page ( ) of the romfs file system reads data of one page and writes the data into the kept physical memory area. The page exception processing part 124 sets, in the page table entry at which the exception occurred, the physical address of the page to which the data has been written with the write protect attribute. After that, the page exception processing part 124 returns from the page exception.

Next, the before-mentioned page exception process at the time of data writing is described in detail. When a page exception occurs, the page exception processing part 124 obtains a virtual address at which the page exception occurs from a control register of the CPU 1. Next, the page exception processing part 124 searches the vmmap 121 of a currently executed process for values corresponding to the virtual address.

If a vnode obtained from the vmmap 121 is effective, the page exception processing part 124 obtains a type of the file system from the vnode. Then, a physical memory area of one page is kept in the RAM 2. Then, the get_page ( ) is called by specifying an offset from the head of the area and a vnode. The get_page ( ) of the romfs file system reads data of one page from the device and writes the data into the physical memory area. The page exception processing part 124 sets, in the page table entry at which the exception occurred, the physical address of the page to which the data has been written with a write enabled attribute. After that, the page exception processing part 124 returns from the page exception.

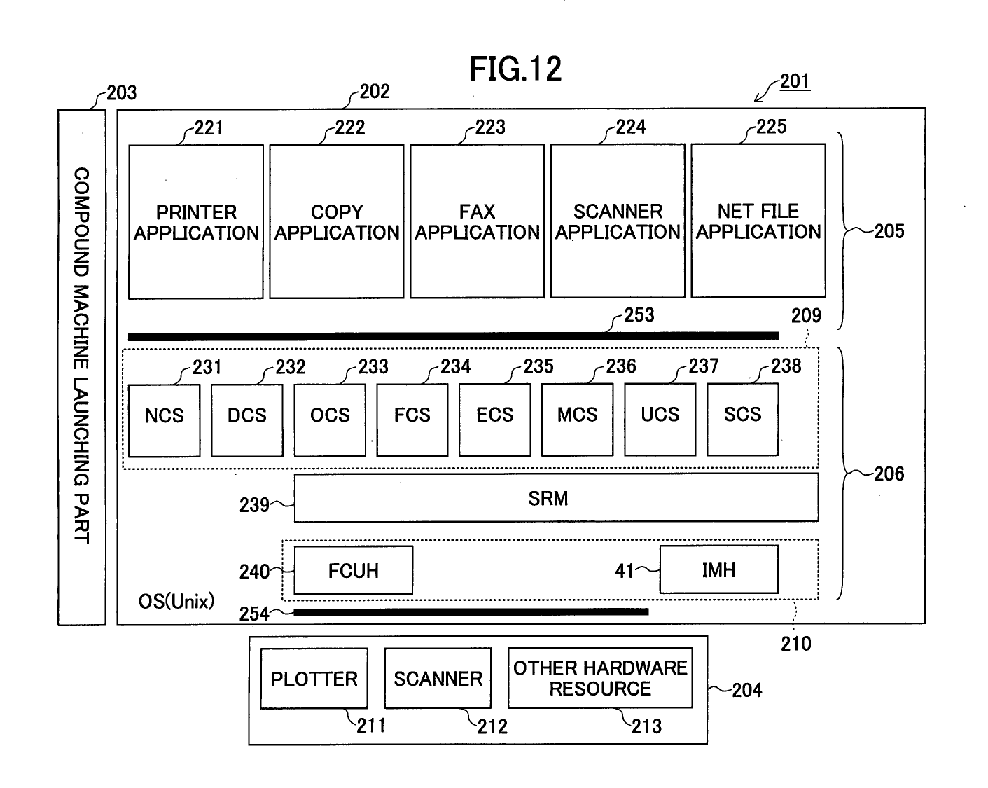

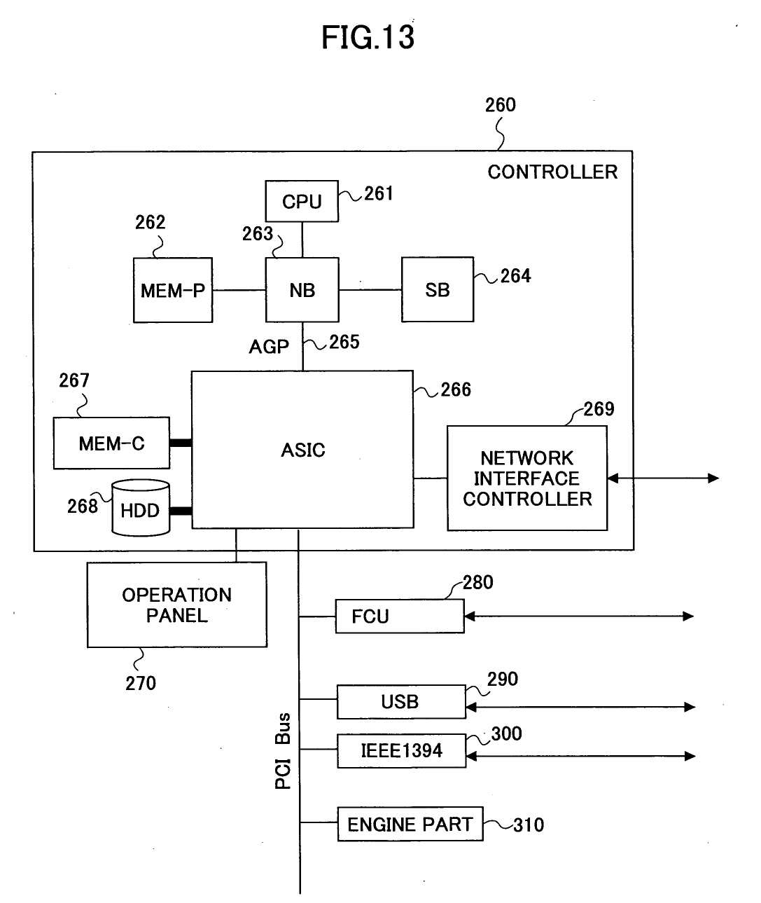

The file management method of the present invention can be applied to a compound machine shown in FIGS. 12 and 13, for example. FIG. 12 is a block diagram of an example of the compound machine. The compound machine is an image processing apparatus that includes functions of a printer, a copier, a facsimile and a scanner and the like in the body. The compound machine can be also referred to as a composite machine, a multifunctional machine or the like.

The compound machine 201 includes a software group 202, a compound machine launching part 203, and hardware resources 204. The compound machine launching part 203 is executed first when the compound machine 201 is turned on, and launches an application layer 205 and a platform 206. For example, the compound machine launching part 203 reads programs of the application layer 205 and the platform 206 from a HDD and transfers the programs to memory areas to launch the programs.

The hardware resources 204 include a plotter 211, a scanner 212 and other hardware resources 213 such as a facsimile. The software group 202 includes the application layer 205 and the platform 206 that are launched on an OS such as UNIX.

The application layer 205 includes programs specific to user services relating to image forming processes such as printing, copying, sending/receiving facsimile and scanning. The application layer 205 includes a printer application 221, a copy application 222, a fax application 223, a scanner application 224, and a network file application 225. The network file application 225 is an application for a network file, and is used for managing data communications between the compound machine 201 and a network apparatus that is connected to the compound machine 201 via a network.

The platform 206 includes a control service layer 209 for interpreting a process request from the application layer 205 to issue an acquiring request for the hardware resources 204, a system resource manager (SRM) 239 for managing one or more hardware resources and arbitrating the acquiring requests from the control service layer 209, and a handler layer 210 for managing the hardware resources 204 in response to the request from the SRM 239.

The control service layer 209 includes a plurality of service modules, which are a network control service (NCS) 231, a delivery control service (DCS) 232, an operation panel control service (OCS) 233, a fax control service (FCS) 234, an engine control service (ECS) 235, a memory control service (MCS) 236, a user information control service (UCS) 237, and a system control service (SCS) 238. In addition, the platform 120 has application program interfaces (API) 253 that can receive process requests from the application layer 205 by using predetermined functions. The OS can execute each piece of software of the platform 206 and the application layer 205 concurrently as processes.

The process of the NCS 231 distributes data received from the network by each protocol to a corresponding application, and acts as mediation between the application and the network when sending data to the network. For example, the NCS 231 controls data communications with a network apparatus connected to the compound machine via a network.

The process of the DCS 232 controls delivery of document data stored in the compound machine. The process of the OCS 233 controls an operation panel that is a means for transferring information between the operator (user) and control parts of the machine. The process of the FCS 234 provides APIs for sending and receiving of facsimile from the application layer 205 by using PSTN/ISDN network, registering/referring of various kinds of facsimile data managed by BKM (backup SRAM), facsimile reading, facsimile receiving and printing and the like.

The process of the ECS 235 controls engine parts such as the plotter 211, the scanner 212 and the hardware resources 213. The process of the MCS 236 performs memory control such as obtaining and releasing an area of a memory, using the HDD, and compressing and expanding image data.

The process of the SCS 238 performs application management, control of the operation part, display of system screen, LED display, hardware resource management, and interrupt application control. The process of the SRM 239 is for performing control of the system and performing management of resources with the SCS 238. The process of the SRM 239 performs arbitration and execution control for requests from the upper layer that uses hardware resources such as the scanner 212 and the plotter 211.

More specifically, the SRM 239 determines whether the requested hardware resource is available (whether it is not used by another request), and, when the requested hardware resource is available, notifies the upper layer that the requested hardware resource is available. In addition, the SRM 239 performs scheduling for using hardware resources 204 for the requests from the upper layer, and directly performs processes corresponding to the requests (for example, paper transfer and image forming by a printer engine, allocating memory area, file generation and the like).

The handler layer 210 includes a fax control unit handler (FCUH) 240 and an image memory handler (IMH) 241. The FCUH 240 manages an after-mentioned fax control unit. The IMH 241 assigns memory spaces to processes and manages the assigned memory spaces.

The SRM 239 and the FCUH 240 send process requests to the hardware resources 204 by using engine I/F 254 by using predetermined functions.

By adopting the configuration shown in FIG. 12, the compound machine 201 can perform processes common to each application by using the platform 206. Next, a hardware configuration of the compound machine 201 is described.

FIG. 13 shows an example of a hardware configuration of the compound machine 201. The compound machine 201 includes a controller 260, an operation panel 270, a FCU 280, a USB device 290, an IEEE 1394 device 300 and an engine part 310.

The controller 260 includes a CPU 261, a system memory (MEM-P) 262, a north bridge (NB) 263, a south bridge (SB) 264, an ASIC 266, a local memory (MEM-C) 267, a HDD 268, and a network interface controller 269.

The operation panel 270 is connected to the ASIC 266 of the controller 260. The FCU 280, the USB device 290, the IEEE 1394 device 300 and the engine part 310 are connected to the ASIC 266 of the controller 260 via the PCI bus.

In the controller 260, the ASIC 266 are connected to the local memory 267, the HDD 268 and the network interface controller 269. The CPU 261 and the ASIC 266 are connected via the NB 263 that is a CPU chip set. By connecting the CPU 261 and the ASIC 266 via the NB 263, a case where the interface of the CPU 261 is not disclosed can be supported.

The ASIC 266 and the NB 263 are connected via an AGP (Accelerated Graphics Port) 265 not via the PCI bus. By adopting this configuration, the performance is not degraded even when more than one processes of the application layer 205 and the platform 206 are executed since the AGP 265 is faster than the PCI bus.

The CPU 261 performs whole control of the compound machine 201. The CPU 261 launches and executes the NCS 231, the DCS 232, the OCS 233, the FCS 234, the ECS 235, the MCS 236, the UCS 237, the SCS 238, the SRM 239, the FCUH 240 and the IMH 241 on the OS as processes. In addition, the CPU 261 launches and executes the printer application 221, the copy application 222, the fax application 223, the scanner application 224 and the net-file application that forms the application layer 205.

The NB 263 is a bridge for connecting the CPU 261, the system memory 262, the SB 264 and the ASIC 266. The system memory 262 is a memory used for drawing images. The SB 264 is a bridge for connecting the NB 263 to the ROM, the PCI bus and the peripheral devices. The local memory 267 is a memory used as a copy image buffer and a code buffer.

The ASIC 266 is an IC suitable for image processing that includes hardware components for image processing. The HDD 268 is a storage for storing image data, document data, programs, font data, forms and the like. The network interface controller 269 communicates with a network apparatus connected via a network by using MAC address and the like. The operation panel 270 is an operation part that receives inputs from an operator and displays data to the operator.

The present invention is not limited to the specifically disclosed embodiments, and variations and modifications may be made without departing from the scope of the present invention.

The present application contains subject matter related to Japanese patent application No.2003-308715, filed in the JPO on Sep. 1, 2003, the entire contents of which being incorporated herein by reference.

1. An information processing apparatus that uses a virtual memory function for executing a program, the information processing apparatus comprising:
a file management part for managing a file in a read-only memory;
a table generation part for generating a table in which a physical address of the program in the file in the read-only memory is associated with a virtual address of the program;
a program execution part for obtaining the physical address of the program in the read-only memory by using the table from the virtual address of the program so as to execute the program on the read-only memory.

2. The information processing apparatus as claimed in claim 1, wherein the table generation part copies a part that may be rewritten in the program into a random-access memory from the read-only memory, and generates a table in which a physical address of the part that may be rewritten in the random-access memory is associated with a virtual address of the part that may be rewritten.

3. The information processing apparatus as claimed in claim 2, wherein the table generation part generates a table in which a physical address of a part having no possibility of being rewritten in the program in the read-only memory is associated with a virtual address of the part having no possibility of being rewritten.

4. The information processing apparatus as claimed in claim 3, wherein the part that may be rewritten is a data area and the part having no possibility of being rewritten is a code area.

5. The information processing apparatus as claimed in claim 1, wherein the table generation part copies a part for which a rewriting instruction is issued in the program into a random-access memory from the read-only memory page by page, and generates a table in which a physical address of the part for which the rewriting instruction is issued in the random-access memory is associated with a virtual address of the part for which the rewriting instruction is issued.

6. The information processing apparatus as claimed in claim 5, wherein the table generation part generates a table in which a physical address of a part for which a rewriting instruction is not issued in the program in the read-only memory is associated with a virtual address of the part for which the rewriting instruction is not issued.

7. The information processing apparatus as claimed in claim 1, wherein the table generation part determines whether the program is managed by a file management part that manages the file in the read-only memory on the basis of a page exception that occurs when the program is executed, and generates the table when it is determined that the program is managed by the file management part that manages the file in the read-only memory.

8. The information processing apparatus as claimed in claim 7, wherein the determination determining whether the program is managed by the file management part that manages the file in the read-only memory is performed by a vnode in an operating system.

9. The information processing apparatus as claimed in claim 7, wherein, when the program is managed by a file management mechanism that manages a file in a random-access memory, the table generation part generates a table in which a physical address of the program in the random-access memory is associated with a virtual address of the program.

10. The information processing apparatus as claimed in claim 7, wherein the program execution part issues the page exception if the physical address of the program in the read-only memory corresponding to the virtual address of the program is not registered in any table when the program is executed.

11. The information processing apparatus as claimed in claim 1, wherein the information processing apparatus includes hardware resources used for image formation processing and more than one programs for performing image formation processing.

12. A file management method used in an information processing apparatus that uses a virtual memory function for executing a program, the file management method comprising:
a table generation step of generating a table in which a physical address of the program in a file in a read-only memory is associated with a virtual address of the program;
a program execution step of obtaining the physical address of the program in the read-only memory by using the table from the virtual address of the program so as to execute the program on the read-only memory.

13. The file management method as claimed in claim 12, wherein the information processing apparatus copies a part that may be rewritten in the program into a random-access memory from the read-only memory, and generates a table in which a physical address of the part that may be rewritten in the random-access memory is associated with a virtual address of the part that may be rewritten.

14. The file management method as claimed in claim 13, wherein the information processing apparatus generates a table in which a physical address of a part having no possibility of being rewritten in the program in the read-only memory is associated with a virtual address of the part having no possibility of being rewritten.

15. The file management method as claimed in claim 14, wherein the part that may be rewritten is a data area and the part having no possibility of being rewritten is a code area.

16. The file management method as claimed in claim 12, wherein the information processing apparatus copies a part for which a rewriting instruction is issued in the program into a random-access memory from the read-only memory page by page, and generates a table in which a physical address of the part for which the rewriting instruction is issued in the random-access memory is associated with a virtual address of the part for which the rewriting instruction is issued.

17. The file management method as claimed in claim 16, wherein the information processing apparatus generates a table in which a physical address of a part for which a rewriting instruction is not issued in the program in the read-only memory is associated with a virtual address of the part for which the rewriting instruction is not issued.

18. The file management method as claimed in claim 12, wherein the information processing apparatus determines whether the program is managed by a file management part that manages the file in the read-only memory on the basis of a page exception that occurs when the program is executed, and generates the table when it is determined that the program is managed by the file management part that manages the file in the read-only memory.

19. The file management method as claimed in claim 18, wherein the determination determining whether the program is managed by the file management part is performed by a vnode in an operating system.

20. The file management method as claimed in claim 18, wherein, when the program is managed by a file management part that manages a file in the random-access memory, the information processing apparatus generates a table in which a physical address of the program in the random-access memory is associated with a virtual address of the program.

21. The file management method as claimed in claim 18, wherein the information processing apparatus issues a page exception if the physical address of the program in the read-only memory corresponding to the virtual address of the program is not registered in any table when the program is executed.
